(19) United States
(12) Patent Application Publication
(10) Pub. No.: US 2004/0202771 A1
(43) Pub. Date: Oct. 14, 2004

(54) Processes for food waste sludge and animal blood

(75) Inventor: John H. Lee, Olathe, KS (US)

Correspondence Address: John H. Lee, 1441 N Lucy Montgomery Way, Olathe, KS, 66061, US

(73) Assignee: Rigel Technology Corporation, Shawnee, KS (US)

(21) Appl. No.: 10/411,855

(22) Filed: Apr. 14, 2003

(51) Int. Cl. A23L 1/31

(52) U.S. Cl. 426/641; 426/656

(57) ABSTRACT

Two novel processing methods of producing an improved food waste sludge product and an improved animal blood product with good nutritional value, yellowish color, mild smell, and low micro counts from the food waste sludge of dissolved air flotation (DAF) units, the sludge fat and animal blood of food processing plants are provided. The products are used for feed and fertilizer nutritional applications. The fat-protein product from the food waste sludge and animal blood also has the bypass and protection functions of the fat and protein for dairy animals to produce more milk at lower cost. The process to convert the food waste sludge from food processing plants into a value-added product with good nutritional value, yellowish color, mild smell, and low micro counts by the economical processing method could save millions of dollars for food and feed industries.

Inventors: Lee; John H.;
1441 N. Lucy Montgomery Way Street, Olathe, KS 66061 (US)
Assignee: Rigel Technology Corporation,
11800 W. 63 Street, Shawnee, KS 66203 (US)
Reference Cited:
U.S. patent Documents

| | | | |
|---|---|---|---|
| 4138505 | Feb. 6, 1979 | Hart et al. | 426/573 |
| 4180592 | Dec. 25, 1979 | Buckley et al. | 426/32 |
| 4216234 | Aug. 5, 1980 | Rawlings et al. | 426/2 |
| 4217370 | Aug. 12, 1980 | Rawlings et al. | 426/98 |
| 4808429 | Feb. 28, 1989 | Freeman | 426/647 |
| 5151500 | Sep. 29, 1992 | Wismer-Pedersen et al. | 530/385 |
| 5496572 | Mar. 5, 1996 | Rudden | 426/74 |
| 5514388 | May 7, 1996 | Rohwer | 426/231 |
| 5874102 | Feb. 23, 1999 | La Joie et al. | 424/438 |
| 5880266 | Mar. 9, 1999 | De Buyser | 530/385 |
| 6229031 | May 8, 2001 | Strohmaier et al. | 554/156 |
| 6235339 | May 22, 2001 | Harmon et al. | 426/646 |
| 6368657 | Apr. 9, 2002 | Lee | 426/658 |

Other References

H. W. Ockerman and C. L. Hansen, “Animal By-Product Processing &
Utilization”, Technomic Publishing Company, Inc., 2000, pp. 457-509.

### FIELD OF THE INVENTION

The present invention relates to the processing methods of treating the food by-products, and more particularly to the encapsulated and decolored processing method of converting the food waste sludge from dissolved air flotation (DAF) units and decolored processing method of producing the animal blood from food processing plants into usable value-added products with good nutritional value, yellowish color, mild smell, and low micro counts for feed and fertilizer applications. Some of the products have the bypass and protection functions of the fat and protein for dairy animals to produce more milk.

### BACKGROUND OF THE INVENTION

Food such as animal meat processing plants have high BOD (biological oxygen demand), COD (chemical oxygen demand), FOG (fats, oils and grease), SS (suspended solids) and TKN (total Kjeldahl nitrogen) in the waste water. Dissolved air flotation (DAF) units are used in food such as animal meat processing plants and waste water treatment plants. The purpose of DAF units is to reduce BOD, COD, SS, FOG and TKN in the waste water passing to sewage treatment. But it creates a problem to dispose of the pasty and oily DAF waste sludge, which has nutrients of fat, protein, carbohydrate and others. Fat and protein is about 88% of the oily sludge on a solids basis from a typical animal processing plant. For an average poultry processing plant, there is about 15,000 tons (or 30,000,000 pounds) of the oily and pasty sludge per year. It is difficult to increase the solid level for the DAF sludge because of the oily characteristics. The typical DAF sludge from poultry processing plants is about 18% solids with such as about ⅔ fat and ⅓ protein on a solids basis.

There are three common methods to deal with the DAF sludge currently. Land spread is often used because it is cheap and easy method. But it causes pollution problems to the land, water and air. A related fee is usually charged. The potential nutritive value of the DAF sludge is lost through microbiological degradation, which produces more microorganisms. Another method is to cook the DAF sludge to about 220 degree F. and to centrifuge into DAF sludge fat, solution and solid phases. The DAF sludge fat has low value compared with the normal fat ingredients. The solution is very cloudy with protein, fat and mineral ingredients. Then the three or two phase products are processed and treated separately. But the prices for the fat and solid products may be lower compared with the processing cost. The third method is to blend the DAF sludge with other by-products into such as poultry meal. But the blended product price is decreased because of the low quality. The fat quality is also affected because of its high free fatty acid level. There is no fat encapsulation in the process. Also the dry processing cost is high because the sludge has about 82% moisture. If the DAF sludge can be converted into value-added products with good nutritional value, light color, mild smell, and low micro counts by an economical processing method, food and feed industries could save millions of dollars.

Animal blood is a protein by-product in animal processing plants. Animal blood is a protein rich source. But animal whole blood and red blood cells have limited applications because of its intense dark color and special blood smell.

Over the years, various attempts have been made to use the oily DAF sludge, to make fat-protein encapsulation and to improve animal blood. A number of patents have been issued for these attempts. U.S. Pat. No. 6,368,657 discloses a method for preparing the DAF sludge into a fat-protein product with animal blood by a heat treatment. But the product still has the intense reddish dark color. U.S. Pat. No. 6,235,339 discloses a process method to treat a meat processing waste stream with different chemicals. U.S. Pat. No. 6,229,031 discloses a method for preparing fatty acid calcium salt products with calcium oxide at very high pH such as 12. The calcium soap salt products have the bypass function for ruminant animals to produce more milk. The soap smell and processing cost are two concerns. U.S. Pat. No. 5,880,266 discloses a process for removing the reddish color heme group from the blood globin fraction by water dilution, pH change, ultrafiltration and pH reverse. U.S. Pat. No.5,874,102 discloses a method for a dietary fatty acid salt product in granulated form with a polymeric coating. U.S. Pat. No. 5,514,388 discloses a process to treat protein with a base to increase the pH to such as 11 at first. Then the fat is added into the alkali protein. The protein firm gel is formed when the pH is lowed to 3 to 5. There is high ash in the product because of the acid and base. U.S. Pat. No. 5,496,572 discloses a process to form a ruminant feed stuff by a homogeneous mixture of animal or vegetable protein nutritional material, one or more fatty acids, and a calcium or magnesium compound by an extrusion process. U.S. Pat. No. 5,151,500 discloses a process by treating animal blood to low pH. The iron is removed by centrifugation process. Then the supernatant is treated with an oxidizing agent. U.S. Pat. No. 4,808,429 discloses a process to encapsulate animal blood and fat by heating to a temperature in the range 40-45 degree C. and homogenizing into a dispersion or emulsion. Then the mixture was allowed to set for forming a gel. The gel still has the intense reddish dark color and blood smell. U.S. Pat. No. 4,217,370 discloses a process to treat protein with a base to increase the pH to such as 11. Then the fat is added into the alkali protein. The protein and fat are mixed together before any pH change. The protein gel is formed when the pH is lowed to the isoelectric point. U.S. Pat. No. 4,216,234 discloses a process to render albumin medium with strongly alkaline such as 11.5 prior to the formation of the fat dispersion or emulsion, and thereafter the dispersion or emulsion is heated to form a gel. U.S. Pat. No. 4,180,592 discloses a process by a reversal pH or heat and an excess oxidizing agent after which the excess oxidizing agent is removed by adding additional amount of blood. The product color is still reddish. U.S. Pat. No. 4,138,505 discloses a process to heat animal blood to a temperature in the range of from about 20° C. to 60° C., to adjust the pH of the heated aqueous medium to a level ranging from 9 to about 13 to form a blood solid gel, and thereafter recovering the fat-protein gel.

We have found that the DAF sludge can be encapsulated by liquid animal blood protein to form a fat-protein product (U.S. Pat. No. 6,368,657). The solid level is increased by mechanical methods. Then the wet or dry product can be used for nutritional applications, which has no oily physical characteristics. But the intense dark color and blood smell still are concerns for the fat-protein product. There is the need make the encapsulated fat-protein and animal blood products into usable value-added products with good nutritional value, light color, mild smell, and low micro counts. It is very important to use food by-products for economic and public health achievements.

### SUMMARY OF THE INVENTION

The present invention overcomes the problems of other patents and provides two novel processes to convert the DAF sludge or DAF sludge fat into a fat-protein encapsulated product and to make animal blood with good nutritional value, yellowish color, mild smell, and low micro counts. The objective of the present invention is to provide the process methods, which are convenient and economical to use.

The DAF sludge is mixed with liquid animal blood. The fat and protein rate depends on the mixture rate and raw materials. The DAF sludge from animal processing plants is a fat and protein source and animal blood is a protein source. The adjustment for pH can be done if it is necessary. Then a heat source is applied to heat the mixture to a temperature above 60 degree C. (or above 140 degree F.) to form a fat-protein encapsulated product. After the fat-protein encapsulated product is formed, the intense reddish color of the encapsulated product is improved into a yellowish color by a decolorized process with peroxide such as hydrogen peroxide, calcium peroxide or sodium peroxide. The product color is changed into a yellowish color with low-level peroxide such as 0.25%. A centrifuge or screen process is often applied to remove the free water before a drying process for reducing the drying cost. The peroxide compound, which may be from a single source or mixture source, may be added into the fat-protein encapsulated products before or after the centrifuge or screen process. The peroxide may react on the surface of the product for the color change, which may not damage the encapsulated fat. Also the product has low micro counts and mild smell. The wet fat-protein encapsulated product may have longer shelf life because it has been treated with the peroxide compound. The peroxide compound has the function to remove bad smell and to kill bacteria. Formaldehyde-type chemicals, EDTA, calcium, and other chemicals also can be used for helping the process for more coagulation and decontamination. The product and process have improved over our early developed product in our U.S. Pat. No. 6,368,567. The product may be used as a single product or blended product with other byproducts such as feather meal, poultry meal, meat and bone meal easily. The major contents of the DAF sludge are fat and protein. The rate of fat and protein may vary at different processing plants and different seasons. The DAF sludge can be processed such as large bulk, heat and extraction processes into the DAF sludge fat material at a stable fat level. The fat level can be much more stable than the fat level in DAF sludge. Such as the fat may be extracted from the DAF sludge by heating to about 100 degree C. and centrifuging the mixture. The top layer is fat. The raw material with a stable fat level can be used for making the capsulated fat-protein products at constant levels for fat and protein with liquid animal blood because the raw materials are constant for fat and protein levels. Additionally, the intense reddish product can be improved into the product with a yellowish color and mild smell. The product may have bypass and protection functions to help dairy animals to produce more milk at lower cost. The product is more economical compared with the current bypass fat or protein products in the market. There are still no the commercial products with both bypass fat and protein together in the market. The product produced with the new novel process has advantages to provide both bypass fat and protein together at lower cost.

Common animal blood is from poultry blood and livestock blood in slaughterhouse plants. Poultry blood has a solid about 12%, which is different from pork and bovine blood. Livestock blood has a solid about 18% or red blood cells, which is separated from plasma, has a solid about 30%. We have found injecting water steam into animal blood to raise animal whole blood or red blood cells to a temperature above 60° C. for a period of time such as from 0.1 to 20 minutes and then mixing a peroxide at low level to make animal blood into an improved product with good nutritional value, yellowish color, mild smell, and low micro counts. Additional fat, oil and water may help the process for lower viscosity and hardness. The viscosity of poultry blood after a heat coagulation treatment such as steam treatment is lower compared with livestock blood. The hardness of poultry blood after the coagulation and peroxide treatments is also lower. Besides steam injection method, indirect heat such as heat jacket or exchange may also be used to raise the temperature for poultry blood in the process because of its lower viscosity and hardness. The viscosity and hardness in the processes for livestock blood after the coagulation and peroxide treatments can be reduced by additional fat, oil and water. But the added water is wasteful because the additional water is dried in a drying process. A peroxide such as hydrogen peroxide is added at such as 0.05% to 2.5%, which is preferred at 0.2% to 0.8% against liquid animal blood weight. There is not much difference between weight basis and volume basis. Besides a peroxide, formaldehyde-type chemicals, EDTA and other chemicals also can be used for helping the process for more coagulation and decontamination. After the above processes, centrifuge, screen and press processes can be applied to remove the free water to increase the solids and reduce drying cost. Then a conventional dryer can be used to yield the dry product with mild smell, yellowish color, low micro counts and decontamination. The product also can be in wet form. The pH range is from 4 to 10. A high speed pump can be used to break the product into very fine form. If a highly soluble product is desired, the liquid product can be hydrolyzed by a hydrolysis process. The value of pH can be adjusted to certain level for optimized process. After the hydrolysis process, heat and vacuum can be applied for the concentration purpose. The product after the hydrolysis process can be dried by a spray dryer. As a result of the processing conditions, the process does not result in the formation of any by-product such as heme by-product. Therefore, the products of the invention will retain all protein with 100% recovery if there is no processing loss, which is much better than other process methods.

The processes with heat, peroxide and formaldehyde-type chemicals have been approved to be used for decontamination for killing bacteria and limiting disease transfer such as from animal by-products to animals through animal feeds. The processed products have no the bacteria such as E. Coli, Salmonella and Coliforms, and have yellowish color, mild smell and decontamination because of the treatments. The quantity of hydrogen peroxide is not remained in the dry products without any treatment because hydrogen peroxide is often used at about 0.2-0.8% level in most cases, which is reacted with animal blood proteins. It is undetectable in the dry products. The nutritional analysis data show the processed products have similar nutrients comparing with the starting materials.

### DETAIL DESCRIPTION OF THE PREFERRED EMBODIMENTS

The following examples set forth preferred methods in accordance with the invention. It is to be understood, however, that these examples are provided by way of illustration and nothing therein should be taken as a limitation upon the overall scope of the invention.

### EXAMPLE 1

The waste sludge from a pork dissolved air flotation (DAF) unit (100 grams) was mixed with liquid bovine blood red blood cells (60 grams). The mixture was mixed and heated to 88° C. for 0.5 minutes. Hydrogen peroxide (2.2 mil of 30% concentration) was added at 0.4% level under mixing. A centrifuge was applied to remove the free water. The wet solid with yellowish color and mild smell was dried in an oven at 105 degree C. for 5 hours. The analytical data were as follows: fat (37.1%), protein (49.9%), moisture (6.1%), ash (2.5%), plate counts (300 cfu/g), and Salmonella (negative). The fat-protein product had no oily physical characteristics on the product.

### EXAMPLE 2

The poultry blood (150 grams) was steamed and heated 88° C. with a mixer for 0.5 minute. Hydrogen peroxide (1.5 ml of 30% concentration) was added under mixing. A centrifuge was applied to remove the free water. The wet solid with yellowish color and mild smell was dried in an oven at 105 degree C. for 4.5 hours. The analytical data were as follows: protein (85.6%), moisture (5.2%), ash (4.1%), plate counts (500 cfu/g), and Salmonella (negative).

### EXAMPLE 3

The sludge from a poultry dissolved air flotation (DAF) unit (200 grams) was mixed with liquid poultry blood (290 grams). The mixture was mixed and heated to 92° C. with a mixer for 1 minute. The free water was screened and pressed. Hydrogen peroxide (1.5 ml of 30% concentration) was added at 0.45% level into the wet solid (100 grams) under mixing. The wet solid with yellowish color and mild smell was dried in an oven at 105 degree C. for 5 hours. The analytical data were as follows: fat (26.1%), protein (62.1%), moisture (5.6%), ash (3.4%), plate counts (not detected), E. coli (not detected), Salmonella (negative), yeast (not detected), and mold (not detected). The fat-protein product had no oily physical characteristics on the product.

### EXAMPLE 4

The fat material processed from poultry DAF sludge by a heat and centrifuge process (25 grams) was mixed with liquid poultry blood (200 grams). The mixture was mixed and heated to 90° C. for 1 minute. The product was screened and pressed and dried in an oven at 105 degree C. for 5 hours. The analytical data were as follows: fat (41.5%), protein (48.8%), moisture (6.2%), ash (3.2%), plate counts (500 cfu/g), and Salmonella (negative). The product had the bypass protein 96% and the bypass fat 70% by the incubation in rumen fluid for 24 hours. The fat-protein product had no oily physical characteristics on the product.

What is claimed is:

1. A method of preparing a food waste sludge product with a yellowish color comprising mixing the food waste sludge from dissolved air flotation units with liquid animal blood, heating the mixture to a temperature above 60 degree C., and then adding a peroxide under mixing to change the reddish color into a yellowish color to form the product.

2. The method of claim 1 wherein the food waste sludge from the dissolved air flotation units is collected during waste water treatment in food or animal processing plants.

3. The method of claim 1 wherein the animal blood is from animal whole blood or red blood cells.

4. The method of claim 1 wherein the level of the peroxide from hydrogen peroxide, sodium peroxide and calcium peroxide is added at 0.05 to 3% on a peroxide solids basis against the wet product weight before or after removing the free water.

5. The method of claim 1 wherein the product is dry or wet.

6. A method of preparing an animal blood product with a yellowish color and mild smell comprising injecting water steam to raise animal blood to a temperature above 60 degree C. and adding a peroxide under mixing into a yellowish color and mild smell to form the product.

7. The method of claim 6 wherein the animal blood is from animal whole blood or red blood cells.

8. The method of claim 6 wherein additional fat, oil or water may be added for reducing the viscosity and hardness in the process.

9. The method of claim 6 wherein the level of the peroxide from hydrogen peroxide, sodium peroxide and calcium peroxide is added at 0.05 to 3% on a peroxide solids basis against the wet product weight before or after removing the free water.

10. The method of claim 6 wherein the product is dry or wet.

11. A method of preparing a food waste sludge fat product comprising mixing the fat ingredient with liquid animal blood and heating the mixture to a temperature above 60 degree C. to form the product.

12. The method of claim 11 wherein the fat ingredient is processed from the food waste sludge from dissolved air flotation units during waste water treatment in food or animal processing plants to have a stable and high fat level in the fat ingredient.

13. The method of claim 11 wherein additional peroxide from hydrogen peroxide, sodium peroxide and calcium peroxide may be added at 0.05 to 3% on a peroxide solids basis against the wet product weight before or after removing the free water to change the reddish color into a yellowish color.

14. The method of claim 11 wherein the product is dry or wet.

15. The method of claim 11 wherein the product with fat and protein has no oily physical characteristics on the product.
